(19) United States
(12) Patent Application Publication
(10) Pub. No.: US 2025/0100050 A1
(43) Pub. Date: Mar. 27, 2025

(54) METHOD AND APPARATUS FOR PRODUCING INORGANIC POWDER USING CHEMICAL VAPOR SYNTHESIS

(71) Applicant: KOREA INSTITUTE OF INDUSTRIAL TECHNOLOGY, Cheonan-si (KR)

(72) Inventors: Seungmin YANG, Gangneung-si (KR); Ohyung Kwon, Gangneung-si (KR); Youngkyu Jeong, Hwaseong-si (KR); Gyeongbae Park, Gangneung-si (KR)

(21) Appl. No.: 18/890,420

(22) Filed: Sep. 19, 2024

(30) Foreign Application Priority Data
Sep. 22, 2023 (KR) 10-2023-0127118
Sep. 22, 2023 (KR) 10-2023-0127119
Sep. 10, 2024 (KR) 10-2024-0122994
Sep. 10, 2024 (KR) 10-2024-0122995

(51) Int. Cl. B22F 9/28; C01B 21/072; C01F 7/306; C01G 3/02; C01G 53/04

(52) U.S. Cl. CPC B22F 9/28; C01B 21/072; C01F 7/306; C01G 3/02; C01G 53/04; B22F 2301/10; B22F 2301/15

(57) ABSTRACT

Provided is a method and apparatus for producing inorganic powder using chemical vapor synthesis (CVS), the method and apparatus being capable of increasing a production yield by suppressing side reactions and of increasing continuous process stability by preventing reactor blockage, and the method includes supplying a precursor, supplying a side reaction prevention gas capable of preventing side reactions of the precursor, to the precursor, supplying a reaction gas to the precursor, and forming inorganic powder due to a chemical reaction between the precursor and the reaction gas.

### CROSS-REFERENCE TO RELATED PATENT APPLICATIONS

This application claims the benefit of Korean Patent Applications No. 10-2023-0127118, filed on Sep. 22, 2023, No. 10-2023-0127119, filed on Sep. 22, 2023, No. 10-2024-0122994, filed on Sep. 10, 2024, and No. 10-2024-0122995, filed on Sep. 10, 2024, in the Korean Intellectual Property Office, the disclosure of which is incorporated herein in its entirety by reference.

### BACKGROUND OF THE INVENTION

### 1. Field of the Invention

The present invention relates to a method of producing inorganic powder and, more particularly, to a method and apparatus for producing inorganic powder using chemical vapor synthesis (CVS), the method and apparatus being capable of increasing a production yield by suppressing side reactions and of increasing continuous process stability by preventing reactor blockage.

### 2. Description of the Related Art

Inorganic powder such as metal powder or ceramic powder are utilized in various technical fields. For example, nickel powder among metal powders are used for electrode layers of multilayer ceramic capacitors (MLCCs). As a chip-type capacitor that temporarily charges electricity in an electronic circuit or removes noise, the MLCC is a component that stores current and stably supplies electricity as needed to properly operate an electronic device. The core technology in MLCCs is to laminate thin nickel electrode layers as many as possible.

One of methods of producing metal powder or ceramic powder is chemical vapor synthesis (CVS). CVS refers to a method of producing a solid-phase substance due to a chemical reaction between a vaporized precursor and a reaction gas. When a chloride is used as the precursor, because the chloride contains water due to its high hygroscopicity, water may react with the chloride to form an oxide at an undesired position, and thus reactor blockage may be caused. As such, a production yield of inorganic powder and continuous process stability may be reduced.

### SUMMARY OF THE INVENTION

The present invention provides a method and apparatus for producing inorganic powder using chemical vapor synthesis (CVS), the method and apparatus capable of increasing a production yield by suppressing side reactions and of increasing continuous process stability by preventing reactor blockage.

However, the above description is an example, and the scope of the present invention is not limited thereto.

According to an aspect of the present invention, there is provided a method and apparatus for producing inorganic powder using chemical vapor synthesis (CVS).

The method of producing inorganic powder using chemical vapor synthesis (CVS) may include supplying a precursor, supplying a side reaction prevention gas capable of preventing side reactions of the precursor, to the precursor, supplying a reaction gas to the precursor, and forming inorganic powder due to a chemical reaction between the precursor and the reaction gas.

The side reaction prevention gas may suppress formation of a metal oxide due to a chemical reaction between the precursor and water or oxygen.

Water may be provided as being chemically or physically adsorbed onto the precursor or combined with the precursor in a form of a hydrate.

The side reaction prevention gas may be the same as a portion of products formed due to a chemical reaction between the precursor and water or oxygen.

The side reaction prevention gas may suppress formation of a portion of products formed due to a chemical reaction between the precursor and water or oxygen, thereby suppressing the chemical reaction between the precursor and water or oxygen.

The side reaction prevention gas may suppress or delay formation of the inorganic powder due to a chemical reaction between the precursor and the reaction gas.

The side reaction prevention gas may be the same as a portion of products formed due to a chemical reaction between the precursor and the reaction gas.

The side reaction prevention gas may suppress formation of a portion of products formed due to a chemical reaction between the precursor and the reaction gas, thereby suppressing the chemical reaction between the precursor and the reaction gas.

The precursor may include one or more of elements constituting the side reaction prevention gas.

A non-metallic element of the precursor and a non-metallic element of the side reaction prevention gas may be the same substance.

The precursor may include one or more of a metal chloride, a metal acetate, a metal bromide, a metal carbonate, a metal carbonyl, a metal fluoride, a metal hydroxide, a metal iodide, a metal nitrate, a metal oxide, a metal phosphate, a metal silicate, a metal sulfate, and a metal sulfide.

A metal constituting the precursor may include one or more of nickel, copper, silver, iron, aluminum, silicon, boron, cobalt, platinum, gold, tin, magnesium, tungsten, niobium, molybdenum, zinc, yttrium, zirconium, ruthenium, iridium, tantalum, and titanium.

The side reaction prevention gas may include one or more of hydrogen chloride gas (HCl), acetic acid gas (C₂H₄O₂), hydrogen bromide gas (BrH), carbonic acid gas (H₂CO₃), hydrogen fluoride gas (HF), water vapor (H₂O), hydrogen iodide gas (HI), nitric acid gas (HNO₃), phosphoric acid gas (H₃PO₄), silicon hydride gas (SiH₄), hydrogen gas (H₂), sulfuric acid gas (H₂SO₄), chlorine gas (Cl₂), and hydrogen sulfide gas (H₂S).

The reaction gas may include a reducing gas including one or more of hydrogen gas, carbon monoxide gas, magnesium vapor gas, sodium vapor gas, and calcium vapor gas, an oxidizing gas including one or more of oxygen gas, water vapor gas, and ozone gas, a nitriding gas including one or more of ammonia gas and nitrogen gas, or a carburizing gas including one or more of methane gas and acetylene gas.

The inorganic powder may include metal powder.

The inorganic powder may include ceramic powder.

The method of producing inorganic powder using chemical vapor synthesis (CVS) may include supplying a precursor, supplying a side reaction prevention gas capable of preventing side reactions of the precursor, to the precursor, supplying a reaction gas to the precursor, and forming metal powder due to a chemical reaction between the precursor and the reaction gas.

The precursor may be nickel chloride, the side reaction prevention gas may be hydrogen chloride gas, the reaction gas may be hydrogen gas, the metal powder may be nickel powder, and the hydrogen chloride gas may suppress formation of nickel oxide formed due to a chemical reaction between the precursor and water.

A relationship between a partial pressure of the hydrogen chloride gas and a partial pressure of water may satisfy the following range.

P^{H2O}/P_{HCl}²≤10⁶

A relationship between the partial pressure of the hydrogen chloride gas and a partial pressure of the hydrogen gas may satisfy the following range.

10⁻¹⁸≤P_{H2}/P_{HCl}²

The precursor may be copper chloride, the side reaction prevention gas may be hydrogen chloride gas, the reaction gas may be hydrogen gas, the metal powder may be copper powder, and the hydrogen chloride gas may suppress formation of copper oxide formed due to a chemical reaction between the precursor and water.

A relationship between a partial pressure of the hydrogen chloride gas and a partial pressure of water may satisfy the following range.

P^{H2O}/P_{HCl}²≤10¹⁵

A relationship between the partial pressure of the hydrogen chloride gas and a partial pressure of the hydrogen gas may satisfy the following range.

10⁻³⁰≤P_{H2}/P_{HCl}²

The method of producing inorganic powder using chemical vapor synthesis (CVS) may include supplying a precursor, supplying a side reaction prevention gas capable of preventing side reactions of the precursor, to the precursor, supplying a reaction gas to the precursor, and forming ceramic powder due to a chemical reaction between the precursor and the reaction gas.

The apparatus for producing inorganic powder using chemical vapor synthesis (CVS) may include a reaction chamber for providing a reaction space where a precursor reacts with a reaction gas to form inorganic powder, a precursor supplier for supplying the precursor to the reaction chamber, a side reaction prevention gas supplier for supplying a side reaction prevention gas capable of preventing side reactions of the precursor, to the precursor, and a reaction gas supplier for supplying the reaction gas to the precursor.

The apparatus may further include a heater for providing heat in such a manner that the precursor chemically reacts with the reaction gas to form the inorganic powder.

The side reaction prevention gas supplier may include a first side reaction prevention gas supplier disposed inside the precursor supplier to supply the side reaction prevention gas to an inside of the precursor supplier.

The side reaction prevention gas supplier may include a second side reaction prevention gas supplier disposed outside the precursor supplier to supply the side reaction prevention gas to an outside of the precursor supplier.

The side reaction prevention gas supplier may be integrated with the precursor supplier.

The side reaction prevention gas and the precursor may be supplied simultaneously or at different timings.

The apparatus may further include an internal precursor storage mounted inside the precursor supplier to store the precursor.

The precursor supplier may include a nozzle for supplying a precursor in a vaporized state.

The reaction chamber may include a vaporization zone where the precursor is vaporized, a reaction zone where the precursor reacts with the reaction gas to form inorganic powder, and a collection zone where the inorganic powder is collected.

The reaction chamber may include one or more of a vertical reaction chamber with a hollow extending in a vertical direction, a horizontal reaction chamber with a hollow extending in a horizontal direction, and a diagonal reaction chamber with a hollow extending in a diagonal direction.

### BRIEF DESCRIPTION OF THE DRAWINGS

The above and other features and advantages of the present invention will become more apparent by describing in detail embodiments thereof with reference to the attached drawings in which:

FIGS. 1 and 2 are cross-sectional views of apparatuses for producing inorganic powder by performing a method of producing inorganic powder using chemical vapor synthesis (CVS), according to embodiments of the present invention.

FIG. 3 is a flowchart of a method of producing inorganic powder using CVS, according to an embodiment of the present invention.

FIG. 4 is a cross-sectional view showing the blockage of a precursor supplier due to side reactions in a method of producing inorganic powder using CVS, according to an embodiment of the present invention.

FIG. 5 is a graph showing the changes in Gibbs free energy with temperature for chemical reactions of nickel chloride occurring in a method of producing inorganic powder using CVS, according to an embodiment of the present invention.

FIG. 6 is a graph showing a result of calculating phase contents for nickel chloride based on addition of a side reaction prevention gas in a method of producing inorganic powder using CVS, according to an embodiment of the present invention.

FIGS. 7, 8, and 9 are graphs specifically showing the changes in Gibbs free energy with temperature for chemical reactions of nickel chloride occurring in a method of producing inorganic powder using CVS, according to an embodiment of the present invention.

FIG. 10 is a graph showing the changes in Gibbs free energy with temperature for chemical reactions of copper chloride occurring in a method of producing inorganic powder using CVS, according to an embodiment of the present invention.

FIG. 11 is a graph showing the changes in Gibbs free energy with temperature for chemical reactions of aluminum chloride occurring in a method of producing inorganic powder using CVS, according to an embodiment of the present invention.

FIG. 12 includes photographic images showing the state of a reaction chamber based on whether side reactions are prevented in a method of producing inorganic powder using CVS, according to an embodiment of the present invention.

FIG. 13 is a microscopic image of inorganic powder formed based on a method of producing inorganic powder using CVS, according to an embodiment of the present invention.

### DETAILED DESCRIPTION OF THE INVENTION

Hereinafter, the present invention will be described in detail by explaining embodiments of the invention with reference to the attached drawings. The invention may, however, be embodied in many different forms and should not be construed as being limited to the embodiments set forth herein, rather, these embodiments are provided so that this disclosure will be thorough and complete, and will fully convey the concept of the invention to one of ordinary skill in the art. Like reference numerals refer to like elements throughout. Further, various elements and regions in the drawings are schematically illustrated. Therefore, the scope of the present invention is not limited by the relative sizes or distances shown in the attached drawings.

As used herein, a “precursor” means a precursor for producing inorganic powder and refers to a compound including a metal element and used to produce inorganic powder. The precursor may form metal powder or ceramic powder as the inorganic powder which is a final product.

The term “side reaction” means a reaction in which inorganic powder of nickel, nickel oxide, aluminum oxide, or the like is formed and attached to the inside and outside of a precursor supplier, together with a reaction in which an oxide such as nickel oxide or aluminum oxide is formed.

For example, when metal powder such as nickel powder is synthesized as a final product, the side reaction may refer to a reaction in which nickel oxide is formed and attached to the precursor supplier before the precursor meets a reaction gas, or to a reaction in which nickel is formed and attached to the precursor supplier after the precursor meets the reaction gas.

When ceramic powder such as aluminum oxide powder is synthesized as a final product, the side reaction may refer to a reaction in which aluminum oxide is formed and attached to the precursor supplier before and after the precursor meets the reaction gas.

That is, because the blockage of the precursor supplier may be caused when the above-mentioned substance is attached to the precursor supplier, the formation of the substance needs to be suppressed.

The term “side reaction prevention gas” refers to a gas capable of preventing the above-described side reaction and means a gas for causing a reverse reaction to suppress the formation of or remove oxide or inorganic powder, e.g., hydrogen chloride.

A method of producing inorganic powder using chemical vapor synthesis (CVS), according to the present invention, is a method of producing inorganic powder using CVS between a precursor and a reaction gas. By supplying a side reaction prevention gas to the precursor, the formation of an oxide formed due to a chemical reaction between the precursor and water, which is chemically or physically adsorbed onto the precursor or combined with the precursor in the form of a hydrate, may be suppressed or delayed. In addition, the formation of some inorganic powder formed at an undesired position due to a chemical reaction between the precursor and the reaction gas may be suppressed or delayed.

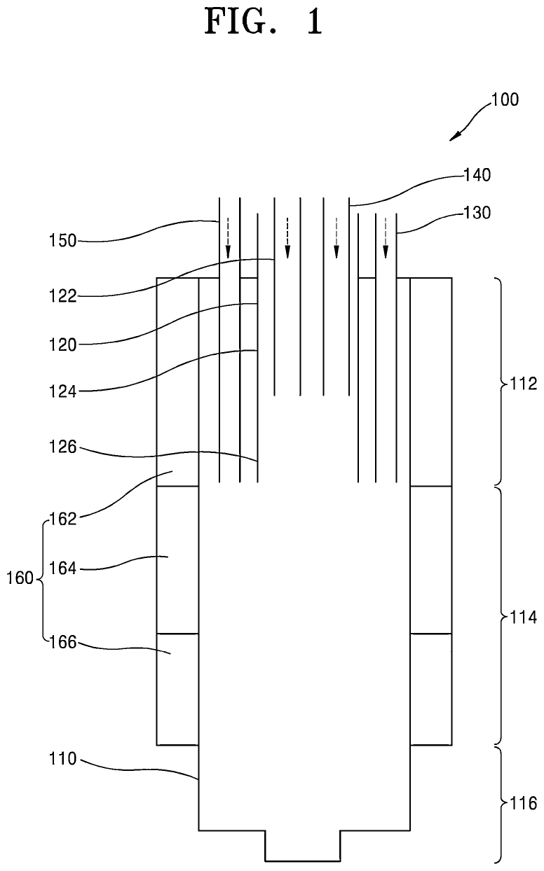

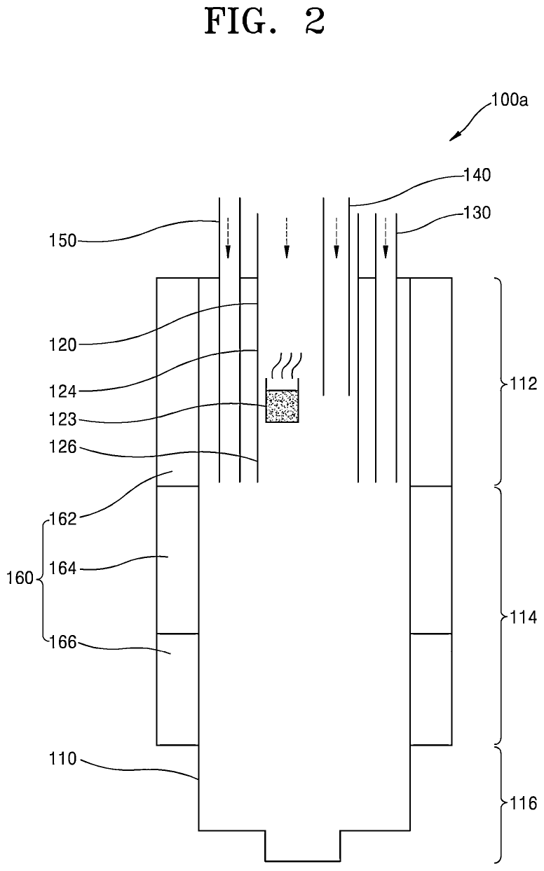

FIGS. 1 and 2 are cross-sectional views of apparatuses 100 and 100a for producing inorganic powder by performing a method of producing inorganic powder using chemical vapor synthesis (CVS), according to embodiments of the present invention.

Referring to FIGS. 1 and 2, the apparatus 100 or 100a may include a reaction chamber 110, a precursor supplier 120, a reaction gas supplier 130, a first side reaction prevention gas supplier 140, a second side reaction prevention gas supplier 150, and a heater 160.

The apparatus 100a of FIG. 2 may further include an internal precursor storage 123 mounted inside the precursor supplier 120 to store a precursor.

The reaction chamber 110 may provide a reaction space where the precursor reacts with a reaction gas to form inorganic powder. Although a vertical reaction chamber with a hollow extending in a vertical direction is illustrated in the drawings, the vertical reaction chamber is merely an example, and the scope of the present invention is not limited thereto. For example, the reaction chamber 110 may be a horizontal reaction chamber with a hollow extending in a horizontal direction or a diagonal reaction chamber with a hollow extending in a diagonal direction.

The reaction chamber 110 may include a vaporization zone 112 where the precursor is vaporized, a reaction zone 114 where the precursor reacts with the reaction gas to form inorganic powder, and a collection zone 116 where the formed inorganic powder is collected.

When the reaction chamber 110 is a vertical reaction chamber, the vaporization zone 112, the reaction zone 114, and the collection zone 116 may be sequentially disposed from an upper side where a gas starts to flow, toward a lower side.

When the reaction chamber 110 is a horizontal or diagonal reaction chamber, the vaporization zone 112, the reaction zone 114, and the collection zone 116 may be sequentially disposed from a side where a gas starts to flow, toward another side where the gas needs to arrive.

The precursor supplier 120 may be disposed at a side of the reaction chamber 110, disposed, for example, in the vaporization zone 112, and disposed, for example, at the upper side. The precursor supplier 120 may supply a vaporized precursor formed by vaporizing the precursor through heating, to the reaction zone 114 of the reaction chamber 110. To this end, the precursor supplier 120 may include the vaporized precursor or various channels through which the vaporized precursor may flow.

The precursor supplier 120 may include a precursor injector 122, a precursor accommodator 124, and a nozzle 126.

The precursor injector 122 may be disposed at an upper side of the precursor supplier 120 and provided as a separate tube or as a portion of the precursor supplier 120. The precursor injector 122 may supply the precursor in a solid phase as a raw material to the precursor accommodator 124 together with a carrier gas by using the flow of the carrier gas. The carrier gas may include, for example, an inert gas such as argon or nitrogen.

As another example, the internal precursor storage 123 is mounted inside the precursor supplier 120 as shown in FIG. 2. The precursor in a solid phase is previously stored in the internal precursor storage 123 and vaporized through heating to release the vaporized precursor from the internal precursor storage 123, and then the vaporized precursor is carried in the reaction chamber 110 by using the carrier gas inserted into the precursor supplier 120.

To supply the precursor to the reaction zone 114 at a uniform flow rate, when the precursor is partially precipitated in the precursor supplier 120, a quenching gas for cooling may be further supplied. The quenching gas may be supplied through the precursor supplier 120 or through an additionally provided channel.

The precursor accommodator 124 may accommodate the precursor vaporized externally or internally. The precursor accommodator 124 may be disposed to correspond to the vaporization zone 112.

The nozzle 126 may be disposed at a lower side of the precursor accommodator 124 to function as a channel through which the vaporized precursor is inserted into the reaction zone 114. In other words, the precursor supplier 120 may include the nozzle 126 for supplying the precursor in a vaporized state. The nozzle 126 has no limitation in shape or path and it has a configuration for supplying the precursor to the reaction zone 114.

The reaction gas supplier 130 may be disposed on the reaction chamber 110 to supply the vaporized precursor or the reaction gas that reacts with the vaporized precursor, into the reaction chamber 110.

The reaction gas may be, for example, a reducing gas, an oxidizing gas, a nitriding gas, or a carburizing gas. The reaction gas may include, for example, a reducing gas including one or more of hydrogen gas, carbon monoxide gas, magnesium vapor gas, sodium vapor gas, and calcium vapor gas, an oxidizing gas including one or more of oxygen gas, water vapor gas, and ozone gas, a nitriding gas including one or more of ammonia gas and nitrogen gas, or a carburizing gas including one or more of methane gas and acetylene gas.

Although the reaction gas supplier 130 is disposed at an upper side of the reaction chamber 110 in the drawings, the illustration is merely an example, and the reaction gas supplier 130 has no limitation in shape or path as long as it has a configuration for directly supplying the reaction gas to the reaction zone 114.

A side reaction prevention gas supplier may include one or more of the first and second side reaction prevention gas suppliers 140 and 150.

The first side reaction prevention gas supplier 140 may supply a side reaction prevention gas. The first side reaction prevention gas supplier 140 may be disposed inside the precursor supplier 120 to supply the side reaction prevention gas to the inside of the precursor supplier 120.

The first side reaction prevention gas supplier 140 may supply the side reaction prevention gas to the inside of the precursor supplier 120 such that the side reaction prevention gas may chemically react with a metal oxide formed due to a chemical reaction between the precursor and water to remove the metal oxide or suppress the formation of the metal oxide. As such, the blockage of the precursor accommodator 124 or the nozzle 126 due to the formation of the metal oxide inside the precursor accommodator 124 or the nozzle 126 may be prevented, quantitative supply of the precursor may be ensured by preventing exhaustion of the precursor, and thus a production yield of inorganic powder and continuous process stability may be increased.

The second side reaction prevention gas supplier 150 may supply a side reaction prevention gas. The second side reaction prevention gas supplier 150 may be disposed outside the precursor supplier 120 to supply the side reaction prevention gas to the outside of the precursor supplier 120.

The second side reaction prevention gas supplier 150 may supply the side reaction prevention gas to the outside of the precursor supplier 120 such that the side reaction prevention gas may chemically react with a metal oxide formed due to a chemical reaction between the precursor and water to remove the metal oxide or suppress the formation of the metal oxide. In addition, the side reaction prevention gas may delay a chemical reaction between the precursor and the reaction gas to remove some of the inorganic powder or suppress the formation of the inorganic powder inside and outside the precursor supplier 120, e.g., inside and outside the precursor accommodator 124 or the nozzle 126. As such, the blockage of the precursor supplier 120 due to the formation of the metal oxide and the inorganic powder inside and outside the precursor supplier 120 may be prevented, quantitative supply of the precursor may be ensured by preventing exhaustion of the precursor, and thus a production yield of inorganic powder and continuous process stability may be increased.

The first side reaction prevention gas supplier 140 is optional and may be omitted. For example, the first side reaction prevention gas supplier 140 may be integrated with the precursor supplier 120. The side reaction prevention gas and the precursor may be supplied simultaneously through the precursor injector 122 of the precursor supplier 120. A case in which the side reaction prevention gas and the precursor are supplied at different timings through the precursor injector 122 of the precursor supplier 120 is also included in the scope of the present invention.

Even when the first side reaction prevention gas supplier 140 and the precursor supplier 120 are provided separately, the side reaction prevention gas may be supplied simultaneously with the precursor. A case in which the side reaction prevention gas and the precursor are supplied at different timings is also included in the scope of the present invention.

The second side reaction prevention gas supplier 150 is also optional and may be omitted. Alternatively, only one of the first and second side reaction prevention gas suppliers 140 and 150 may be selected and provided.

The side reaction prevention gas may include, for example, hydrogen chloride (HCl) gas. However, the hydrogen chloride gas is merely an example, and any gas capable of preventing side reactions may be used as the side reaction prevention gas and included in the scope of the present invention. The side reactions and the side reaction prevention gas will be described in detail below.

The heater 160 may provide heat such that the precursor and the reaction gas chemically react to form inorganic powder. The heater 160 may be disposed on an outer circumferential surface of the reaction chamber 110 to heat the reaction chamber 110. The heater 160 may be configured as, for example, a resistance heater heated by electricity.

The heater 160 may be divided into a plurality of heaters which may be individually controlled in temperature. For example, three heaters, e.g., a first heater 162, a second heater 164, and a third heater 166, may be disposed in a downward direction. The first, second, and third heaters 162, 164, and 166 may be controlled to different temperatures, and thus various temperatures may be implemented at different positions on the reaction chamber 110.

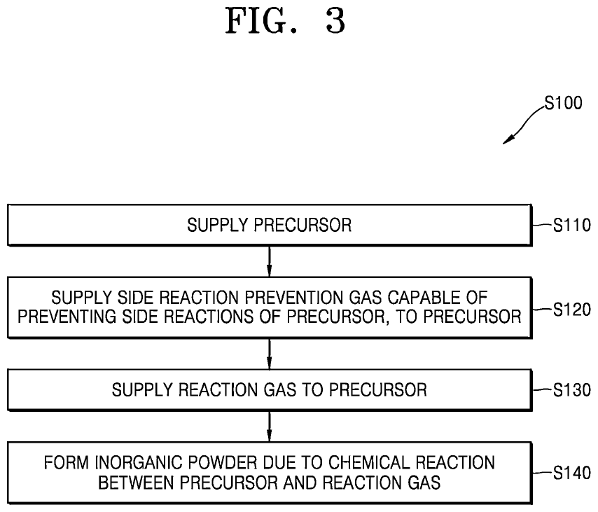

FIG. 3 is a flowchart of a method S100 of producing inorganic powder using CVS, according to an embodiment of the present invention.

Referring to FIG. 3, the method S100 includes supplying a precursor S110, supplying a side reaction prevention gas capable of preventing side reactions of the precursor, to the precursor S120, supplying a reaction gas to the precursor S130, and forming inorganic powder due to a chemical reaction between the precursor and the reaction gas S140.

The side reaction prevention gas may suppress the formation of a metal oxide formed due to a chemical reaction between the precursor and water or oxygen.

The side reaction prevention gas may be the same as a portion of products formed due to the chemical reaction between the precursor and water, and the chemical reaction between the precursor and water may be suppressed according to Le Chatelier's principle.

Water or oxygen may chemically react with the precursor to form the metal oxide.

Water may be provided as being chemically or physically adsorbed onto the precursor or combined with the precursor in the form of a hydrate. Alternatively, water may remain in the reaction chamber, be provided due to leakage, or be included in the carrier gas and the reaction gas. In general, water contains most of its moisture as water of crystallization (chemical bonds). Furthermore, because a reactor may not be 100%-sealed, even a slight leak may cause moisture and oxygen to enter.

In addition, the side reaction prevention gas may suppress or delay the formation of some inorganic powder formed due to a chemical reaction between the precursor and the reaction gas. The side reaction prevention gas may be the same as a portion of products formed due to the chemical reaction between the precursor and the reaction gas, and the chemical reaction between the precursor and the reaction gas may be suppressed according to Le Chatelier's principle.

The precursor may include one or more of elements constituting the side reaction prevention gas. For example, a non-metallic element of the precursor and a non-metallic element of the side reaction prevention gas may be the same substance. For example, both the non-metallic element of the precursor and the non-metallic element of the side reaction prevention gas may be chlorine (Cl). For example, the precursor may be nickel chloride (NiCl₂), the side reaction prevention gas may be hydrogen chloride (HCl), and both the precursor and the side reaction prevention gas may be chlorides. Alternatively, for example, the precursor may be copper chloride (CuCl), the side reaction prevention gas may be HCl, and both the precursor and the side reaction prevention gas may be chlorides. Otherwise, for example, the precursor may be aluminum chloride (AlCl₃), the side reaction prevention gas may be HCl, and both the precursor and the side reaction prevention gas may be chlorides.

The precursor may include one or more of, for example, a metal chloride, a metal acetate, a metal bromide, a metal carbonate, a metal carbonyl, a metal fluoride, a metal hydroxide, a metal iodide, a metal nitrate, a metal oxide, a metal phosphate, a metal silicate, a metal sulfate, and a metal sulfide, but is not limited thereto.

A metal constituting the precursor may include one or more of, for example, nickel, copper, silver, iron, aluminum, silicon, boron, cobalt, platinum, gold, tin, magnesium, tungsten, niobium, molybdenum, zinc, yttrium, zirconium, ruthenium, iridium, tantalum, and titanium. However, the above-mentioned metals are merely examples, and the scope of the present invention is not limited thereto.

For example, the precursor may be a chloride. The precursor may include one or more of, for example, nickel chloride, copper chloride, silver chloride, iron chloride, aluminum chloride, cobalt chloride, platinum chloride, gold chloride, tin chloride, magnesium chloride, tungsten chloride, niobium chloride, molybdenum chloride, zinc chloride, yttrium chloride, zirconium chloride, ruthenium chloride, iridium chloride, tantalum chloride, and titanium chloride. However, the above-mentioned chlorides are merely examples, and the scope of the present invention is not limited thereto.

The side reaction prevention gas may include one or more of, for example, hydrogen chloride gas (HCl), acetic acid gas (C₂H₄O₂), hydrogen bromide gas (BrH), carbonic acid gas (H2CO3), hydrogen fluoride gas (HF), water vapor (H₂O), hydrogen iodide gas (HI), nitric acid gas (HNO₃), phosphoric acid gas (H₃PO₄), silicon hydride gas (SiH₄), hydrogen gas (H₂), sulfuric acid gas (H₂SO₄), chlorine gas (Cl₂), and hydrogen sulfide gas (H₂S). However, the above-mentioned gases are merely examples, and the scope of the present invention is not limited thereto.

The reaction gas may be a reducing gas, an oxidizing gas, a nitriding gas, or a carburizing gas. The reaction gas may include a reducing gas including one or more of hydrogen gas, carbon monoxide gas, magnesium vapor gas, sodium vapor gas, and calcium vapor gas, an oxidizing gas including one or more of oxygen gas, water vapor gas, and ozone gas, a nitriding gas including one or more of ammonia gas and nitrogen gas, or a carburizing gas including one or more of methane gas and acetylene gas. However, the above-mentioned gases are merely examples, and the scope of the present invention is not limited thereto.

A method of producing inorganic powder using the apparatus 100 will now be described.

A precursor for forming desired inorganic powder is injected into the precursor supplier 120 through the precursor injector 122 together with a carrier gas. When the precursor is previously accommodated in the internal precursor storage 123 inside the precursor supplier 120, the precursor injector 122 may inject only the carrier gas for gas flow.

In the precursor supplier 120 disposed in the vaporization zone 112 of the reaction chamber 110, a vaporized precursor is formed by vaporizing the precursor. The vaporization may be performed by the first heater 162 of the heater 160. The vaporized precursor is supplied to the reaction zone 114 of the reaction chamber 110 through the nozzle 126. Furthermore, in the vaporization zone 112, a reaction gas and the carrier gas may be preheated.

In the reaction zone 114 of the reaction chamber 110, the vaporized precursor and the reaction gas supplied through the reaction gas supplier 130 may react with each other to form inorganic powder.

In the collection zone 116 of the reaction chamber 110, the formed inorganic powder is collected. The collected inorganic powder may additionally undergo a series of processes such as classification and washing. Various collection devices and methods may be used and included in the scope of the present invention.

Temperatures of different zones of the reaction chamber 110 may be variously selected depending on the inserted precursor. The vaporization zone 112 may have a temperature range in which the precursor is vaporized, e.g., 20° C. to 1400° C. The reaction zone 114 may have a temperature range in which the precursor reacts with the reaction gas, e.g., 200° C. to 1400° C. The collection zone 116 may have a temperature range in which the formed inorganic powder is precipitated in a solid phase, e.g., 20° C. to 1000° C.

The inorganic powder produced as described above may include, for example, nickel, copper, silver, iron, aluminum, silicon, boron, cobalt, platinum, gold, tin, magnesium, tungsten, niobium, molybdenum, zinc, yttrium, zirconium, ruthenium, iridium, tantalum, titanium, or an alloy thereof. However, the above-mentioned elements are merely examples, and the scope of the present invention is not limited thereto.

Alternatively, the inorganic powder may include, for example, an oxide, nitride, or carbide of nickel, copper, silver, iron, aluminum, silicon, boron, cobalt, platinum, gold, tin, magnesium, tungsten, niobium, molybdenum, zinc, yttrium, zirconium, ruthenium, iridium, tantalum, or titanium. However, the above-mentioned elements are merely examples, and the scope of the present invention is not limited thereto.

The inorganic powder may include metal powder, ceramic powder, or both. For example, the inorganic powder may include one or more of, nickel powder, copper powder, nickel copper alloy powder, aluminum oxide powder, iron aluminum oxide powder, and aluminum nitride powder. However, the above-mentioned powders are merely examples, and the scope of the present invention is not limited thereto.

A method of producing inorganic powder using CVS, according to an embodiment of the present invention, may include supplying a precursor, supplying a side reaction prevention gas capable of preventing side reactions of the precursor, to the precursor, supplying a reaction gas to the precursor, and forming metal powder due to a chemical reaction between the precursor and the reaction gas.

The precursor may be nickel chloride, the side reaction prevention gas may be hydrogen chloride gas, the reaction gas may be hydrogen gas, the metal powder may be nickel powder, and the hydrogen chloride gas may suppress the formation of a metal oxide formed due to a chemical reaction between the precursor and water.

For example, when the precursor is nickel chloride and the synthesized inorganic powder is nickel powder, the method according to an embodiment of the present invention may include supplying nickel chloride, supplying hydrogen chloride gas capable of preventing side reactions of nickel chloride, to nickel chloride, supplying a reaction gas to nickel chloride, and forming nickel powder due to a chemical reaction between nickel chloride and the reaction gas.

For example, after solid-state nickel chloride is vaporized, the vaporized nickel chloride may be supplied to the reaction chamber 110 by a carrier gas, and the nickel chloride may nucleate and grow nickel particles due to a reduction using a reducing gas such as hydrogen, thereby forming the nickel powder.

The hydrogen chloride gas may suppress or delay the formation of nickel oxide due to a chemical reaction between nickel chloride and water. The hydrogen chloride gas may also suppress or delay the formation of the nickel powder due to the chemical reaction between nickel chloride and the reaction gas.

As described above, to prevent the side reactions of nickel chloride, the relationship between partial pressures of the hydrogen chloride gas and water, and the relationship between partial pressures of the hydrogen chloride gas and the hydrogen gas need to be considered.

To suppress or delay the formation of nickel oxide due to the chemical reaction between nickel chloride and water, the relationship between the partial pressure of the hydrogen chloride gas and the partial pressure of water may satisfy the following range.
Gas-phase nickel chloride: P^{H2O}/P_{HCl}²≤10³
Solid-phase nickel chloride: P^{H2O}/P_{HCl}²≤10⁶

When P^{H2O}/P_{HCl}² exceeds 10³, the upper limit for gas-phase nickel chloride, or 106, the upper limit for solid-phase nickel chloride, i.e., when the partial pressure of water is higher, the side reaction prevention effect may be inadequate.

Although the lower limit of P^{H2O}/P_{HCl}² is not defined, excessive supply of the hydrogen chloride gas may slow down the reaction for forming inorganic powder in the reaction zone and thus the lower limit also needs to be controlled. For example, the lower limit of P^{H2O}/P_{HCl}² may be 10⁻¹⁵ for gas-phase nickel chloride or 10⁻⁵ for solid-phase nickel chloride.

To suppress or delay the formation of the nickel powder in the nozzle due to the chemical reaction between nickel chloride and the hydrogen gas, the relationship between the partial pressure of the hydrogen chloride gas and the partial pressure of the hydrogen gas may satisfy the following range.

10⁻¹⁸≤P_{H2}/P_{HCl}²≤10³

On the other hand, the formation of the nickel powder due to the chemical reaction between nickel chloride and the hydrogen gas is required to occur in the reaction zone, and in this case, the relationship between the partial pressure of the hydrogen chloride gas and the partial pressure of the hydrogen gas may satisfy the following range.

10⁻⁸≤P_{H2}/P_{HCl}²

Herein, the upper limit of P^{H2}/P_{HCl}²is not defined but may be, for example, 10^{1000000.}

For example, when the precursor is copper chloride and the synthesized inorganic powder is copper powder, the method according to an embodiment of the present invention may include supplying copper chloride, supplying hydrogen chloride gas capable of preventing side reactions of copper chloride, to copper chloride, supplying a reaction gas to copper chloride, and forming copper powder due to a chemical reaction between copper chloride and the reaction gas.

For example, after solid-state copper chloride is vaporized, the vaporized copper chloride may be supplied to the reaction chamber 110 by a carrier gas, and the copper chloride may nucleate and grow copper particles due to a reduction using a reducing gas such as hydrogen, thereby forming the copper powder.

The hydrogen chloride gas may suppress or delay the formation of copper oxide due to a chemical reaction between copper chloride and water. The hydrogen chloride gas may also suppress or delay the formation of the copper powder due to the chemical reaction between copper chloride and the reaction gas.

As described above, to prevent the side reactions of copper chloride, the relationship between partial pressures of the hydrogen chloride gas and water, and the relationship between partial pressures of the hydrogen chloride gas and the hydrogen gas need to be considered.

To suppress or delay the formation of copper oxide due to the chemical reaction between copper chloride and water, the relationship between the partial pressure of the hydrogen chloride gas and the partial pressure of water may satisfy the following range.
Gas-phase copper chloride: P^{H2O}/P_{HCl}²≤10¹
Solid-phase copper chloride: P^{H2O}/P_{HCl}²≤10¹⁵

When P^{H2O}/P_{HCl}² exceeds 101, the upper limit for gas-phase copper chloride, or 10¹⁵, the upper limit for solid-phase copper chloride, i.e., when the partial pressure of water is higher, the side reaction prevention effect may be inadequate.

Although the lower limit of P^{H2O}/P_{HCl}² is not defined, excessive supply of the hydrogen chloride gas may slow down the reaction for forming inorganic powder in the reaction zone and thus the lower limit also needs to be controlled. For example, the lower limit of P^{H2O}/P_{HCl}² may be 10^{31 25} for gas-phase copper chloride or 10^{31 1} for solid-phase copper chloride.

To suppress or delay the formation of the copper powder in the nozzle due to the chemical reaction between copper chloride and the hydrogen gas, the relationship between the partial pressure of the hydrogen chloride gas and the partial pressure of the hydrogen gas may satisfy the following range.

10⁻³⁰≤P_{H2}/P_{HCl}²≤10¹

On the other hand, the formation of the copper powder due to the chemical reaction between copper chloride and the hydrogen gas is required to occur in the reaction zone, and in this case, the relationship between the partial pressure of the hydrogen chloride gas and the partial pressure of the hydrogen gas may satisfy the following range.

10⁻²⁰≤P_{H2}/P_{HCl}²

Herein, the upper limit of P_{H2}/P_{HCl}² is not defined but may be, for example, 10^{1000000.}

A method of producing inorganic powder using CVS, according to an embodiment of the present invention, may include supplying a precursor, supplying a side reaction prevention gas capable of preventing side reactions of the precursor, to the precursor, supplying a reaction gas to the precursor, and forming ceramic powder due to a chemical reaction between the precursor and the reaction gas.

For example, when the precursor is aluminum chloride and the synthesized inorganic powder is aluminum oxide powder, the method according to an embodiment of the present invention may include supplying aluminum chloride, supplying hydrogen chloride gas capable of preventing side reactions of aluminum chloride, to aluminum chloride, supplying a reaction gas to aluminum chloride, and forming aluminum oxide powder due to a chemical reaction between aluminum chloride and the reaction gas.

For example, after solid-state aluminum chloride is vaporized, the vaporized aluminum chloride may be supplied to the reaction chamber 110 by a carrier gas, and the aluminum chloride may nucleate and grow aluminum oxide particles due to an oxidation using an oxidizing gas such as water, thereby forming the aluminum oxide powder.

The hydrogen chloride gas may suppress or delay the formation of aluminum oxide due to the chemical reaction between aluminum chloride and water provided as the reaction gas.

As described above, to prevent the side reactions of aluminum chloride, the relationship between partial pressures of the hydrogen chloride gas and water needs to be considered.

To suppress or delay the formation of aluminum oxide due to the chemical reaction between aluminum chloride and water, the relationship between the partial pressure of the hydrogen chloride gas and the partial pressure of water may satisfy the following range.
Gas-phase aluminum chloride: P_{H2O}³/P_{HCl}⁶≤10⁻¹
Solid-phase aluminum chloride: P_{H2O}³/P_{HCl}⁶≤10⁻⁵

When P_{H2O}³/P_{HCl}⁶ exceeds 10⁻¹, the upper limit for gas-phase aluminum chloride, or 10⁻⁵, the upper limit for solid-phase aluminum chloride, i.e., when the partial pressure of water is higher, the side reaction prevention effect may be inadequate.

Although the lower limit of P_{H2O}³/P_{HCl}⁶ is not defined, excessive supply of the hydrogen chloride gas may slow down the reaction for forming inorganic powder in the reaction zone and thus the lower limit also needs to be controlled. For example, the lower limit of P_{H2O}³/P_{HCl}⁶ may be 10⁻³⁰ for gas-phase aluminum chloride or 10⁻²⁵ for solid-phase aluminum chloride.

On the other hand, the formation of the aluminum oxide powder due to the chemical reaction between aluminum chloride and water is required to occur in the reaction zone, and in this case, the relationship between the partial pressure of the hydrogen chloride gas and the partial pressure of water may satisfy the following range.

10⁻²⁵≤P_{H2O}³/P_{HCl}⁶

Herein, the upper limit of P_{H2O}³/P_{HCl}⁶ is not defined but may be, for example, 10^{1000000.}

For example, when the precursor is aluminum chloride and the synthesized inorganic powder is aluminum nitride powder, the method according to an embodiment of the present invention may include supplying aluminum chloride, supplying hydrogen chloride gas capable of preventing side reactions of aluminum chloride, to aluminum chloride, supplying a reaction gas to aluminum chloride, and forming aluminum nitride powder due to a chemical reaction between aluminum chloride and the reaction gas.

For example, after solid-state aluminum chloride is vaporized, the vaporized aluminum chloride may be supplied to the reaction chamber 110 by a carrier gas, and the aluminum chloride may nucleate and grow aluminum nitride particles due to a nitrification using a nitriding gas such as ammonia, thereby forming the aluminum nitride powder.

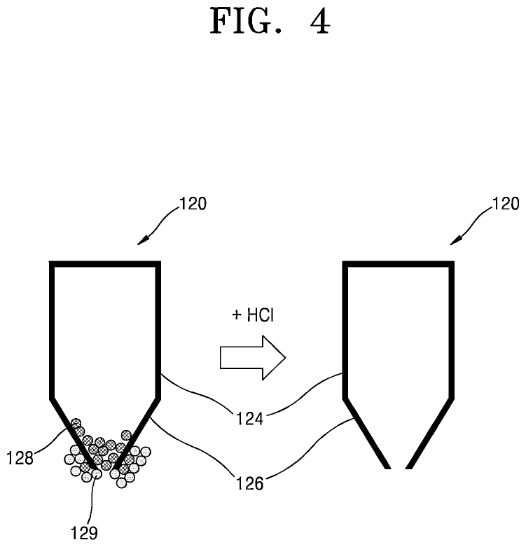

FIG. 4 is a cross-sectional view showing the blockage of the precursor supplier 120 due to side reactions in a method of producing inorganic powder using CVS, according to an embodiment of the present invention.

Referring to FIG. 4, an oxide 128 such as nickel oxide or aluminum oxide may be formed inside the precursor supplier 120 due to the above-described chemical reaction, and then solidified and deposited on the inside of the nozzle 126. The deposition may occur in the precursor accommodator 124 or the nozzle 126 of the precursor supplier 120. Because the oxide 128 consumes a chloride of the precursor, the chloride may not be quantitatively supplied to the reaction zone 114 (see FIG. 1). The oxide 128 may also be solidified and deposited on the outside of the precursor supplier 120. When the oxide 128 is precipitated inside and outside the precursor supplier 120 as described above, a gas pressure may be changed by the undesired consumption of the chloride of the precursor, and thus production process conditions may be changed. Furthermore, the precursor supplier 120, e.g., the nozzle 126, may be blocked from the inside, the outside, or both by the oxide 128.

In addition, when inorganic powder 129 of nickel or aluminum oxide is formed inside and outside the precursor supplier 120 due to the above-described chemical reaction, the inorganic powder 129 may be solidified on the outside of the precursor supplier 120, and a gas pressure may be changed by the undesired consumption of the chloride of the precursor. Furthermore, the precursor supplier 120, e.g., the nozzle 126, may be blocked by the inorganic powder 129.

On the other hand, in a method of producing inorganic powder using CVS, according to an embodiment of the present invention, by additionally providing a side reaction prevention gas such as hydrogen chloride gas, the formation of oxide and inorganic powder inside and outside the precursor supplier 120 may be prevented, quantitative supply of the precursor to the reaction zone may be ensured, pressure changes of the precursor supplier 120 may be prevented, and the blockage of the precursor supplier 120, e.g., the nozzle 126, may also be prevented.

The side reaction prevention gas may be supplied to the inside of the precursor supplier 120 through the precursor injector 122. Alternatively, the side reaction prevention gas may be supplied through the side reaction prevention gas supplier. For example, the side reaction prevention gas may be supplied to the inside of the precursor supplier 120 in the reaction chamber 110 and to the inside of the nozzle 126 through the first side reaction prevention gas supplier 140. For example, the side reaction prevention gas may be supplied to the outside of the precursor supplier 120 in the reaction chamber 110 and to the outside of the nozzle 126 through the second side reaction prevention gas supplier 150.

The side reaction prevention gas may be injected continuously and uniformly, continuously and non-uniformly, discontinuously and uniformly, or discontinuously and non-uniformly.

Functions of side reactions and a side reaction prevention gas in a method of producing inorganic powder using CVS, according to an embodiment of the present invention, will now be described based on thermodynamic theories.

The following description assumes that the precursor is nickel chloride, the reaction gas is hydrogen gas, the inorganic powder is nickel powder, and the side reaction prevention gas is hydrogen chloride gas.

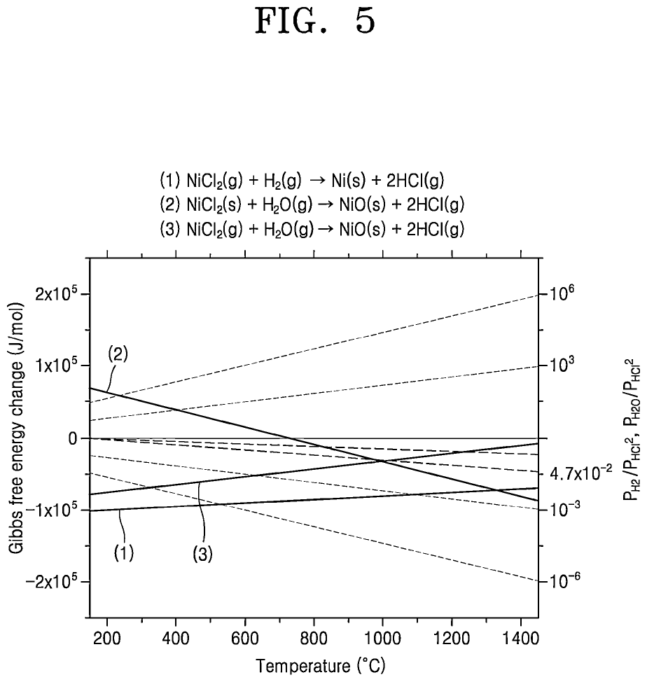

FIG. 5 is a graph showing the changes in Gibbs free energy with temperature for chemical reactions of nickel chloride occurring in a method of producing inorganic powder using CVS, according to an embodiment of the present invention.

Referring to FIG. 5, nickel chloride may undergo reactions shown in the following chemical formulas.

NiCl₂(g)+H₂(g)=>Ni(s)+2HCl(g) [Chemical Formula 1]

NiCl₂(s)+H₂O(g)=>NiO(s)+2HCl(g) [Chemical Formula 2]

NiCl₂(g)+H₂O(g)=>NiO(s)+2HCl(g) [Chemical Formula 3]

When the precursor is nickel chloride, nickel powder may be formed according to Chemical Formula 1.

Based on the Gibbs free energy, at about 1400° C. or below, a reaction in which nickel chloride reacts with hydrogen gas to form nickel is dominant, and the hydrogen gas needs to be provided to this end.

Therefore, in an environment where the hydrogen gas is not provided, e.g., inside the precursor supplier 120, a reaction in which nickel chloride reacts with water to form nickel oxide is dominant. As shown in Chemical Formula 2, before nickel chloride is vaporized, solid-phase NiCl₂(s) may react with H₂O to form nickel oxide (NiO). As shown in Chemical Formula 3, after nickel chloride is vaporized, gas-phase NiCl₂(g) may react with H₂O to form NiO.

The precursor is in a solid phase at room temperature and may include water which is chemically or physically adsorbed onto the precursor or combined with the precursor in the form of a hydrate. In particular, a metal chloride such as nickel chloride is difficult to completely dry and thus includes even a small amount of H₂O and is very hygroscopic and thus very easily adsorbs H₂O or forms a hydrate. Water may not be easily removed though general drying.

In addition, H₂O is highly reactive with NiCl₂(s) and NiCl₂(g) to cause a reaction in which nickel chloride reacts with water to form nickel oxide, thereby consuming nickel chloride, a raw material, and forming undesired NiO. That is, water may chemically react with solid-phase nickel chloride according to Chemical Formula 2. Alternatively, water may chemically react with gas-phase nickel chloride according to Chemical Formula 3. As such, an oxide, e.g., NiO, may be formed.

Because nickel oxide blocks the precursor supplier in the production apparatus or exhausts nickel of the nickel precursor, nickel oxide needs to be removed or the formation of nickel oxide needs to be suppressed.

When nickel oxide is formed as described above, HCl is also formed as another product. To suppress the formation of nickel oxide, a forward reaction may be suppressed, or a reverse reaction may be caused by supplying HCl.

Specifically, when hydrogen chloride is additionally supplied to the inside of the precursor supplier 120, a forward reaction in which nickel chloride reacts with water may be suppressed or a reverse reaction in which nickel oxide reacts with supplied hydrogen chloride may be caused, and thus the formation of nickel oxide may be suppressed, or nickel oxide may be removed.

In addition, nickel formed inside or outside the precursor supplier 120 may be deposited on the precursor supplier 120, e.g., on the nozzle 126, and thus the nozzle 126 may be blocked by nickel. The reactants, NiCl₂(g) and H₂, need to be sufficiently preheated to high reaction temperatures before mixing to ensure a uniform reaction. However, H₂ may diffuse in a direction opposite to the gas flow (i.e., toward the nozzle) due to its high diffusivity, and thus a reaction may occur at an undesired region and nickel may be attached to the nozzle 126 to block the nozzle 126.

Therefore, when hydrogen chloride is additionally supplied to the inside and outside of the precursor supplier 120 through one or more of the first and second side reaction prevention gas suppliers 140 and 150, a forward reaction in which nickel chloride reacts with hydrogen to form nickel may be suppressed or a reverse reaction may be caused. As such, the formation of nickel may be suppressed at an undesired region such as the outside of the precursor supplier 120, e.g., the nozzle 126, and made at a position spaced apart from the precursor supplier 120, e.g., the nozzle 126.

As described above, due to the formation of nickel oxide or nickel, quantitative supply of the NiCl₂ precursor may not be easily ensured and a pressure may occur in the reaction chamber to disable continuous processing. In the present invention, to solve the above problems, undesired reactions may be suppressed by increasing a partial pressure of HCl at a local region.

For Chemical Formula 1, the ratio of P^{H2}/P_{HCl}² needs to be small to suppress the undesired reaction. For Chemical Formulas 2 and 3, the ratio of P^{H2O}/P_{HCl}² needs to be small to suppress the undesired reaction. Herein, P_{H2} is a partial pressure of hydrogen gas, P_{H2O} is a partial pressure of water, and P_{HC l}is a partial pressure of hydrogen chloride gas.

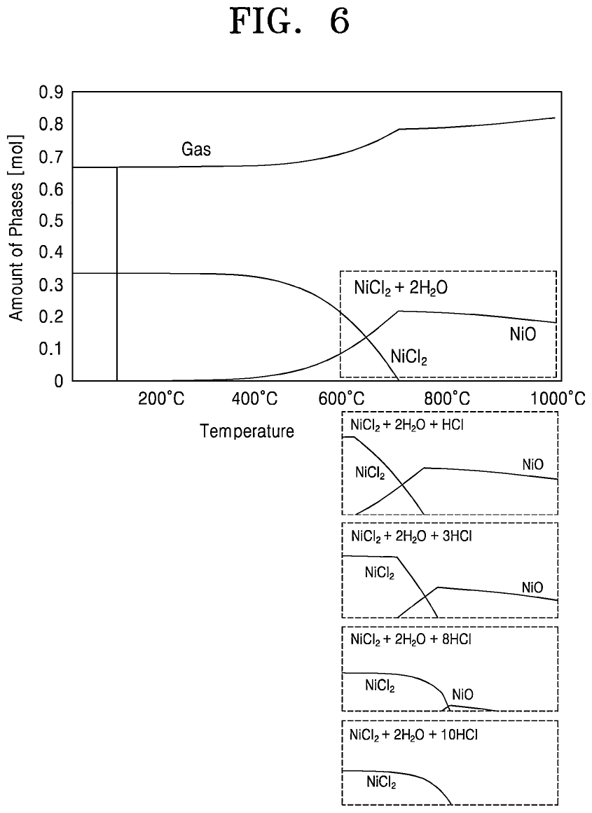

FIG. 6 is a graph showing a result of calculating phase contents for nickel chloride based on addition of a side reaction prevention gas in a method of producing inorganic powder using CVS, according to an embodiment of the present invention.

Referring to FIG. 6, when only NiCl₂ and H₂O are present, NiO starts to be formed at about 300° C., and NiCl₂ is completely changed into NiO at about 750° C. When HCl is provided as a side reaction prevention gas, a formation start temperature of NiO is increased and the amount of formed NiO is reduced. When a molar ratio of NiCl₂ and HCl exceeds 8, NiO is not formed. A required content of the side reaction prevention gas may be calculated based on partial pressures of water and the hydrogen chloride gas.

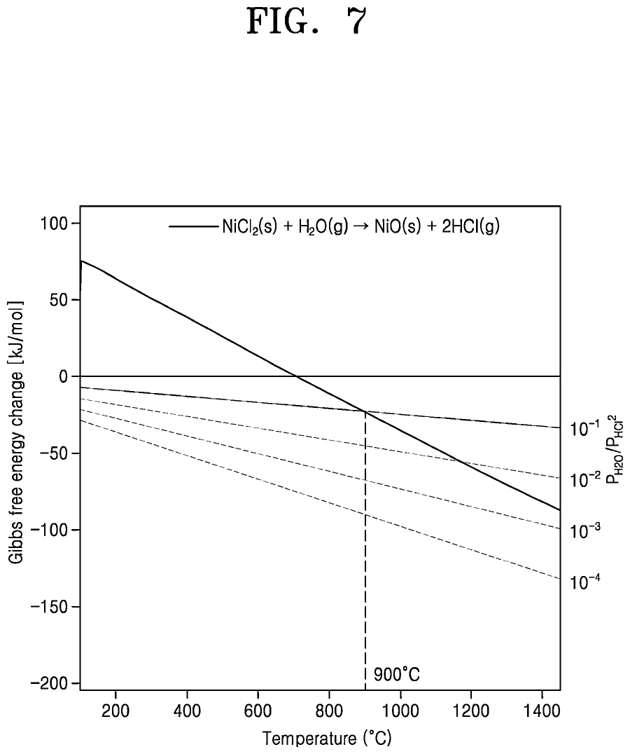

FIGS. 7 to 9 are graphs specifically showing the changes in Gibbs free energy with temperature for chemical reactions of nickel chloride occurring in a method of producing inorganic powder using CVS, according to an embodiment of the present invention.

Referring to FIG. 7, the change in Gibbs free energy with temperature for the chemical reaction between solid-phase NiCl₂(s) and H₂O(g) according to Chemical Formula 2 is shown. Solid-phase NiCl₂ chemically reacts with water at about 700° C. or higher when P^{H2O}/P_{HCl}² is 1. A gas partial pressure appropriate for suppressing the chemical reaction needs to be maintained considering an internal temperature of the reaction chamber. For example, at 900° C., the chemical reaction may be suppressed by providing HCl in an amount capable of forming an atmosphere with P^{H2O}/P_{HCl}² of 0.1 or less.

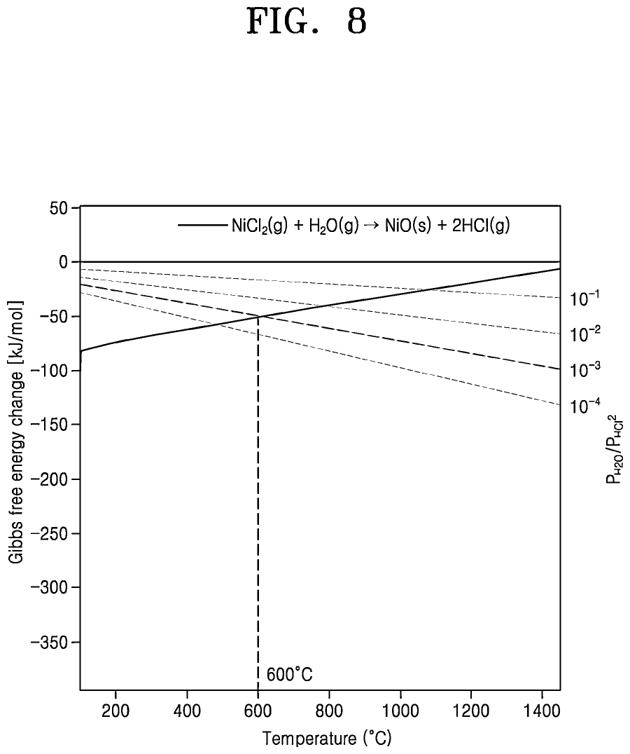

Referring to FIG. 8, the change in Gibbs free energy with temperature for the chemical reaction between gas-phase NiCl₂(g) and H₂O(g) according to Chemical Formula 3 is shown. Gas-phase NiCl₂ reacts with H₂O at 1400° C. or lower when P^{H2O}/P_{HCl}² is 1. However, because the saturated vapor pressure of NiCl₂is low at a low temperature of 600° C. or lower, the reaction needs to be suppressed above a temperature capable of forming a sufficiently effective amount of NiCl₂ gas, and an appropriate gas partial pressure needs to be maintained to this end. For example, because the saturated vapor pressure of NiCl₂ at 600° C. is merely about 13 Pa, the chemical reaction may be mostly suppressed by providing HCl in an amount capable of forming an atmosphere with P^{H2O}/P_{HCl}² of 0.001 or less.

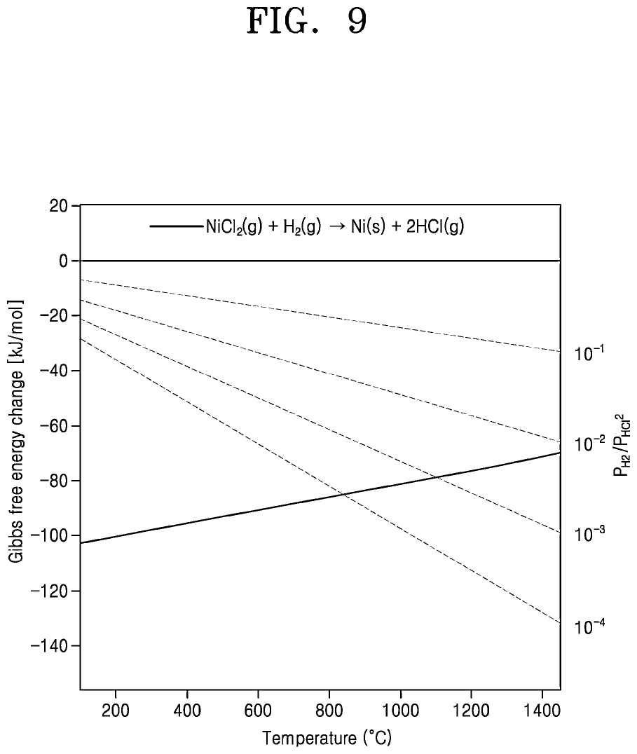

Referring to FIG. 9, the change in Gibbs free energy with temperature for the chemical reaction between gas-phase NiCl₂(g) and H₂(g) according to Chemical Formula 1 is shown. For example, the formation of nickel powder at an undesired region such as the nozzle 126 is due to the diffusion of H₂. A forward or reverse reaction at this region may be determined based on P^{H2}/P_{HCl}². However, because accurate prediction of the value of diffused P_{H2} is not easy, accurate calculation of a required value of P^{H2}/P_{HCl}² is not easy, either. However, the smaller the value of P^{H2}/P_{HCl}², the more the adhesion of nickel may be suppressed.

The following description assumes that the precursor is copper chloride, the reaction gas is hydrogen gas, the inorganic powder is copper powder, and the side reaction prevention gas is hydrogen chloride.

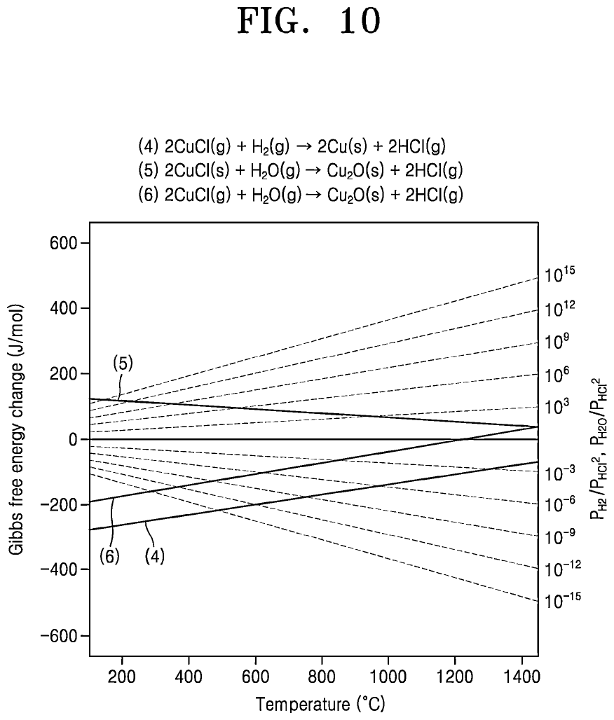

FIG. 10 is a graph showing the changes in Gibbs free energy with temperature for chemical reactions of copper chloride occurring in a method of producing inorganic powder using CVS, according to an embodiment of the present invention.

Referring to FIG. 10, copper chloride may undergo reactions shown in the following chemical formulas.

2CuCl(g)+H₂(g)=>2Cu(s)+2HCl(g) [Chemical Formula 4]

2CuCl(s)+H₂O(g)=>Cu₂O(s)+2HCl(g) [Chemical Formula 5]

2CuCl(g)+H₂O(g)=>Cu₂O(s)+2HCl(g) [Chemical Formula 6]

When the precursor is copper chloride, copper powder may be formed according to Chemical Formula 4.

Based on the Gibbs free energy, at about 1400° C. or below, a reaction in which copper chloride reacts with hydrogen gas to form copper is dominant, and the hydrogen gas needs to be provided to this end.

Therefore, in an environment where the hydrogen gas is not provided, e.g., inside the precursor supplier 120, a reaction in which copper chloride reacts with water to form copper oxide is dominant. As shown in Chemical Formula 5, before copper chloride is vaporized, solid-phase CuCl(s) may react with H₂O to form copper oxide (Cu₂O). As shown in Chemical Formula 6, after copper chloride is vaporized, gas-phase CuCl(g) may react with H₂O to form Cu₂O.

Because copper oxide blocks the precursor supplier in the production apparatus or exhausts copper of the copper precursor, copper oxide needs to be removed or the formation of copper oxide needs to be suppressed.

When copper oxide is formed as described above, HCl is also formed as another product. To suppress the formation of copper oxide, a forward reaction may be suppressed, or a reverse reaction may be caused by supplying HCl.

As described above, when hydrogen chloride is additionally supplied to the inside of the precursor supplier 120, a forward reaction in which copper chloride reacts with water may be suppressed or a reverse reaction in which copper oxide reacts with supplied hydrogen chloride may be caused, and thus the formation of copper oxide may be suppressed, or copper oxide may be removed.

In addition, when hydrogen chloride is additionally supplied, a forward reaction in which copper chloride reacts with hydrogen to form copper may be suppressed or a reverse reaction may be caused. As such, the formation of copper may be suppressed at an undesired region such as the outside of the precursor supplier 120, e.g., the nozzle 126, and made at a position spaced apart from the precursor supplier 120, e.g., the nozzle 126.

For Chemical Formula 4, the ratio of P_{H2}/P_{HCl}² needs to be small to suppress the undesired reaction. For Chemical Formulas 5 and 6, the ratio of P^{H2O}/P_{HCl}² needs to be small to suppress the undesired reaction. Herein, P_{H2} is a partial pressure of hydrogen gas, P_{H2O} is a partial pressure of water, and P_{HCl} is a partial pressure of hydrogen chloride gas.

The following description assumes that the precursor is aluminum chloride, the reaction gas is water, the inorganic powder is aluminum oxide powder, and the side reaction prevention gas is hydrogen chloride.

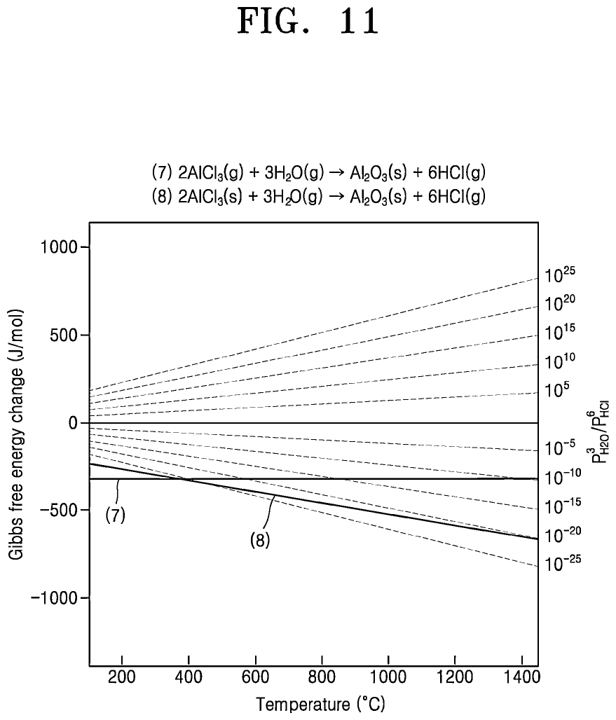

FIG. 11 is a graph showing the changes in Gibbs free energy with temperature for chemical reactions of aluminum chloride occurring in a method of producing inorganic powder using CVS, according to an embodiment of the present invention.

Referring to FIG. 11, aluminum chloride may undergo reactions shown in the following chemical formulas.

2AlCl₃(g)+3H₂O(g)=>Al₂O₃(s)+6HCl(g) [Chemical Formula 7]

2AlCl₃(s)+3H₂O(g)=>Al₂O₃(s)+6HCl(g) [Chemical Formula 8]

When the precursor is aluminum chloride, aluminum oxide powder may be formed according to Chemical Formula 7.

Based on the Gibbs free energy, at about 1400° C. or below, a reaction in which aluminum chloride reacts with water to form aluminum oxide is dominant, and water needs to be provided to this end.

As shown in Chemical Formula 8, before aluminum chloride is vaporized, solid-phase AlCl₃(s) may react with H₂O to form aluminum oxide (Al₂O₃). As shown in Chemical Formula 7, after aluminum chloride is vaporized, gas-phase AlCl₃(g) may react with H₂O to form Al₂O₃.

Although aluminum oxide is desired inorganic powder, because aluminum oxide may block the precursor supplier in the production apparatus when formed at an undesired position, aluminum oxide needs to be removed or the formation of aluminum oxide needs to be suppressed.

When aluminum oxide is formed as described above, HCl is also formed as another product. To suppress the formation of aluminum oxide, a forward reaction may be suppressed, or a reverse reaction may be caused by supplying HCl.

As described above, when hydrogen chloride is additionally supplied to the inside of the precursor supplier 120, a forward reaction in which aluminum chloride reacts with water to form aluminum oxide may be suppressed or a reverse reaction may be caused. As such, the formation of aluminum oxide may be suppressed at an undesired region such as the outside of the precursor supplier 120, e.g., the nozzle 126, and made at a position spaced apart from the precursor supplier 120, e.g., the nozzle 126.

For Chemical Formulas 7 and 8, the ratio of P^{H2O}/P_{HCl}² needs to be small to suppress the undesired reaction. Herein, P_{H2O} is a partial pressure of water, and P_{HCl} is a partial pressure of hydrogen chloride gas.

Similarly to aluminum oxide, the scope of the present invention may also be applied to aluminum nitride which is formed as shown in Chemical Formulas 9 and 10.

3AlCl₃(g)+3NH₃(g)=>3AlN(s)+9HCl(g) [Chemical Formula 9]

3AlCl₃(s)+3NH₃(g)=>3AlN(s)+9HCl(g) [Chemical Formula 10]

Although CVS is used to produce inorganic powder in the above description, CVS is merely an example, and the scope of the present invention is not limited thereto.

The inorganic powder formed as described above may be applied to various fields of fine ceramic. For example, the nickel powder produced using the method and apparatus according to the present invention may be applied to electrode layers of multilayer ceramic capacitors (MLCCs).

### Test Examples

Test examples will now be described for better understanding of the present invention. However, the following test examples are merely to promote understanding of the present invention, and the present invention is not limited to thereto.

The apparatus of FIG. 1 was used to produce inorganic powder.

Solid-phase nickel chloride (NiCl₂) was used as a precursor. A moisture content of nickel chloride measured using a halogen moisture analyzer (HC103, Mettler Toledo) was 0.21 wt %.

As an embodiment, nickel powder was formed in an atmosphere with P_{H2}/P_{HCl}² of 0.0098 in the reaction zone 114 (see FIG. 1) by inserting HCl as a side reaction prevention gas at 0.6 liters per minute (LPM).

As a comparative example, nickel powder was formed without inserting HCl as a side reaction prevention gas.

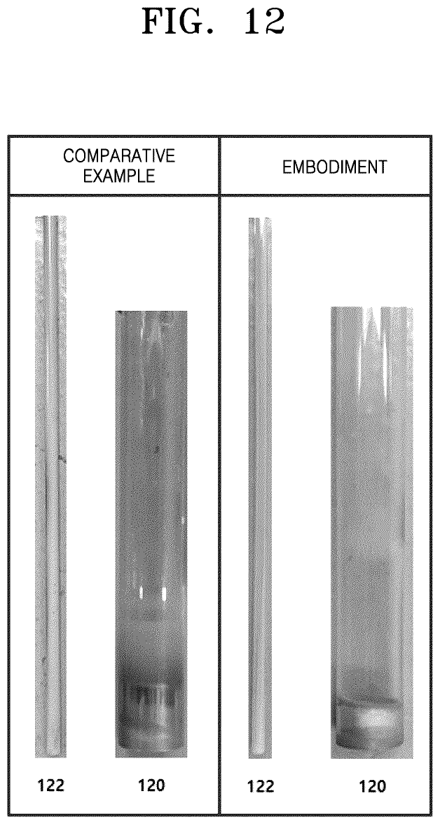

FIG. 12 includes photographic images showing the state of a reaction chamber based on whether side reactions are prevented in a method of producing inorganic powder using CVS, according to an embodiment of the present invention.

Referring to FIG. 12, the states of the precursor injector 122 for providing nickel chloride and the precursor supplier 120 accommodating the precursor injector 122, after nickel powder is formed are shown.

According to the comparative example, when the reaction was made without inserting HCl, nickel oxide was formed on the inner wall of the precursor injector 122. In addition, nickel oxide was formed on the inner wall of a lower side of the precursor supplier 120. Furthermore, a nickel film was formed to a length of about 4 cm from the bottom. It is analyzed that the nickel film was formed because nickel element formed after the chemical reaction are precipitated on the inside or outside of the lower side of the precursor supplier 120, or because fine nickel powder formed in a gas phase after the chemical reaction is thermally treated or collides with the inside or outside of the lower side of the precursor supplier 120.

On the other hand, according to the embodiment, nickel oxide was not formed on the inner wall of the precursor injector 122. In addition, green nickel oxide was not formed on the inner wall of a lower side of the precursor supplier 120. Furthermore, a nickel film was formed to a length of about 2 cm from the bottom, which is shorter than that of the comparative example. It is analyzed that the formation of the nickel film may be further suppressed by increasing the amount of injected HCl and reducing P^{H2}/P_{HCl}².

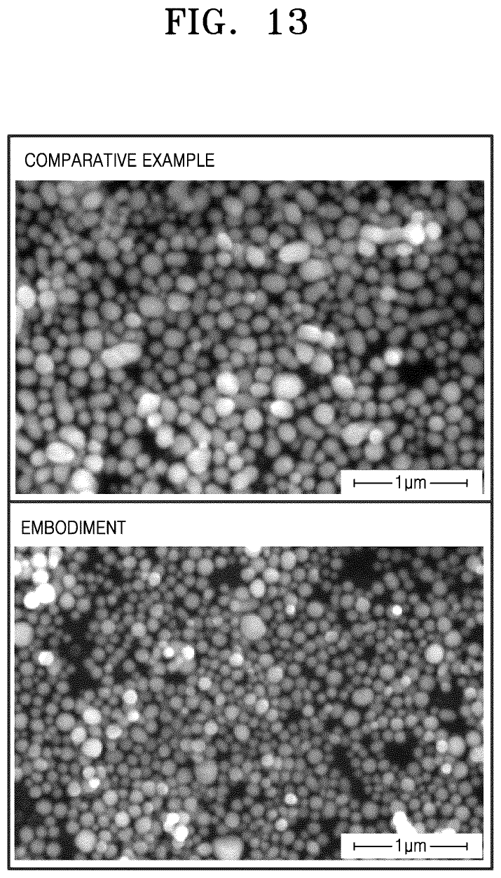

FIG. 13 is a microscopic image of inorganic powder formed based on a method of producing inorganic powder using CVS, according to an embodiment of the present invention.

Referring to FIG. 13, nickel powder formed without using HCl according to the comparative example and nickel powder formed using HCl according to the embodiment exhibit similar characteristics in particle size, distribution, shape, etc.

According to the present invention, based on a method and apparatus for producing inorganic powder using CVS, by supplying a side reaction prevention gas, the formation of a metal oxide due to a chemical reaction between a precursor and water before the precursor reacts with a reaction gas may be suppressed, the formation of inorganic powder of a metal oxide formed at an undesired position due to a chemical reaction between the precursor and water may be suppressed, or the formation of inorganic powder of metal formed at an undesired position due to a chemical reaction between the precursor and the reaction gas may be suppressed. Therefore, reactor blockage by the formation of the metal oxide and the formation of the inorganic powder at the undesired position may be prevented, quantitative supply of the precursor may be ensured by preventing exhaustion of the precursor, and thus a production yield of inorganic powder and continuous process stability may be increased.

The above-described effects of the present invention are merely examples, and the scope of the present invention is not limited thereto.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A method of producing inorganic powder using chemical vapor synthesis (CVS), the method comprising:
supplying a precursor;
supplying a side reaction prevention gas capable of preventing side reactions of the precursor, to the precursor;
supplying a reaction gas to the precursor; and
forming inorganic powder due to a chemical reaction between the precursor and the reaction gas.

2. The method of claim 1, wherein the side reaction prevention gas suppresses formation of a metal oxide due to a chemical reaction between the precursor and water or oxygen.

3. The method of claim 2, wherein water is provided as being chemically or physically adsorbed onto the precursor or combined with the precursor in a form of a hydrate.

4. The method of claim 1, wherein the side reaction prevention gas is the same as a portion of products formed due to a chemical reaction between the precursor and water or oxygen.

5. The method of claim 1, wherein the side reaction prevention gas suppresses formation of a portion of products formed due to a chemical reaction between the precursor and water or oxygen, thereby suppressing the chemical reaction between the precursor and water or oxygen.

6. The method of claim 1, wherein the side reaction prevention gas suppresses or delays formation of the inorganic powder due to a chemical reaction between the precursor and the reaction gas.

7. The method of claim 1, wherein the side reaction prevention gas is the same as a portion of products formed due to a chemical reaction between the precursor and the reaction gas.

8. The method of claim 1, wherein the side reaction prevention gas suppresses formation of a portion of products formed due to a chemical reaction between the precursor and the reaction gas, thereby suppressing the chemical reaction between the precursor and the reaction gas.

9. The method of claim 1, wherein the precursor comprises one or more of elements constituting the side reaction prevention gas.

10. The method of claim 1, wherein a non-metallic element of the precursor and a non-metallic element of the side reaction prevention gas are the same substance.

11. The method of claim 1, wherein the precursor comprises one or more of a metal chloride, a metal acetate, a metal bromide, a metal carbonate, a metal carbonyl, a metal fluoride, a metal hydroxide, a metal iodide, a metal nitrate, a metal oxide, a metal phosphate, a metal silicate, a metal sulfate, and a metal sulfide.

12. The method of claim 11, wherein a metal constituting the precursor comprises one or more of nickel, copper, silver, iron, aluminum, silicon, boron, cobalt, platinum, gold, tin, magnesium, tungsten, niobium, molybdenum, zinc, yttrium, zirconium, ruthenium, iridium, tantalum, and titanium.

13. The method of claim 1, wherein the side reaction prevention gas comprises one or more of hydrogen chloride gas (HCl), acetic acid gas (C₂H₄O₂), hydrogen bromide gas (BrH), carbonic acid gas (H₂CO₃), hydrogen fluoride gas (HF), water vapor (H₂O), hydrogen iodide gas (HI), nitric acid gas (HNO₃), phosphoric acid gas (H₃PO₄), silicon hydride gas (SiH₄), hydrogen gas (H₂), sulfuric acid gas (H₂SO₄), chlorine gas (Cl₂), and hydrogen sulfide gas (H₂S).

14. The method of claim 1, wherein the reaction gas comprises:
a reducing gas comprising one or more of hydrogen gas, carbon monoxide gas, magnesium vapor gas, sodium vapor gas, and calcium vapor gas;
an oxidizing gas comprising one or more of oxygen gas, water vapor gas, and ozone gas;
a nitriding gas comprising one or more of ammonia gas and nitrogen gas; or
a carburizing gas comprising one or more of methane gas and acetylene gas.

15. A method of producing inorganic powder using chemical vapor synthesis (CVS), the method comprising:
supplying a precursor;
supplying a side reaction prevention gas capable of preventing side reactions of the precursor, to the precursor;
supplying a reaction gas to the precursor; and
forming metal powder due to a chemical reaction between the precursor and the reaction gas.

16. The method of claim 15, wherein the precursor is nickel chloride,
wherein the side reaction prevention gas is hydrogen chloride gas,
wherein the reaction gas is hydrogen gas,
wherein the metal powder is nickel powder, and
wherein the hydrogen chloride gas suppresses formation of nickel oxide formed due to a chemical reaction between the precursor and water.

17. The method of claim 16, wherein a relationship between a partial pressure of the hydrogen chloride gas and a partial pressure of water satisfies a range of:
P^{H2O}/P_{HCl}²≤10⁶, and
wherein a relationship between the partial pressure of the hydrogen chloride gas and a partial pressure of the hydrogen gas satisfies a range of:
10⁻¹⁸≤P_{H2}/P_{HCl}².

18. The method of claim 15, wherein the precursor is copper chloride,
wherein the side reaction prevention gas is hydrogen chloride gas,
wherein the reaction gas is hydrogen gas,
wherein the metal powder is copper powder, and
wherein the hydrogen chloride gas suppresses formation of copper oxide formed due to a chemical reaction between the precursor and water.

19. The method of claim 18, wherein a relationship between a partial pressure of the hydrogen chloride gas and a partial pressure of water satisfies a range of:
P^{H2O}/P_{HCl}²≤10¹⁵, and
wherein a relationship between the partial pressure of the hydrogen chloride gas and a partial pressure of the hydrogen gas satisfies a range of:
10⁻³⁰≤P_{H2}/P_{HCl}².

20. A method of producing inorganic powder using chemical vapor synthesis (CVS), the method comprising:
supplying a precursor;
supplying a side reaction prevention gas capable of preventing side reactions of the precursor, to the precursor;
supplying a reaction gas to the precursor; and
forming ceramic powder due to a chemical reaction between the precursor and the reaction gas.
